(19) United States
(12) Patent Application Publication
(10) Pub. No.: US 2008/0126170 A1
(43) Pub. Date: May 29, 2008

(54) Systems and Methods for Retrieving Potential Real Estate Leads

(76) Inventors: Mark H. Leck, Springville, UT (US); Jayson S. Jorgensen, Provo, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/557,422

(22) Filed: Nov. 7, 2006

(51) Int. Cl. G06Q 10/00; G06F 17/30; G06F 7/00; G06F 9/44; G06Q 40/00; G06Q 30/00

(52) U.S. Cl. 705/9; 707/5; 717/168; 707/2; 705/1; 705/7; 705/10; 705/14; 705/30; 707/E17.017; 707/E17.061

(57) ABSTRACT

Computer-implemented methods and systems for retrieving potential real estate leads such as expired MLS listings, for-sale-by-owner properties, and foreclosures are described. Expired listings and/or the other leads may be automatically updated, by scanning several electronic sources to discover owner information and when a property is sold or listed/re-listed with a real estate agent. Missing data from the listings may be identified and completed where possible. Moreover, the systems and methods search for and supplement the leads with supplemental information such as property tax data, population demographics, recent comparable sales in the area, et cetera.

### FIELD OF THE INVENTION

The present invention relates generally to systems and methods for collecting information related to real estate properties. In particular, the present invention relates to systems and methods for compiling comprehensive arid up-to-date data on real estate that may form potential leads for red estate agents.

### BACKGROUND OF THE INVENTION

Is it well known among real estate agents that their income potential significantly increases with the number of properties they are able to list for sale. Thus, it is highly desirable for real estate agents to list as many properties of as many clients as possible. Of course, to increase the number of listings, a real estate agent must successfully identify and pursue potential clients and properties, commonly known as “leads.”

In practice, the pursuit of leads can be a frustrating, time consuming, and difficult practice. Personal solicitations are often the most effective method of converting leads or prospects into new clients. The use of personal solicitations is complicated by the code of ethics for the National Association of Realtors (“NAR”), which indicates that personal solicitations of property owners identified as having exclusively listed their property with another agent are prohibited. Even certain mail solicitations are prohibited under this rule. Furthermore, although not unethical, it appears unprofessional for a real estate agent to solicit representation of a property owner who has already successfully sold his or her property. Thus, a real estate agent pursuing new clients must be careful as to the methods used and the leads pursued, and must carefully confirm that leads are not already represented by another agent,

While there are many potential sources for leads, the information from the various sources is not easily accessible and is often difficult to use. Furthermore, the information from the various sources is often in differing formats and is difficult to confirm and compare with other sources of information. In some instances, real estate agents pursuing leads may daily spend hours searching through the available information to identify proper leads to pursue, and to ensure that the leads pursued are not currently represented by another agent or sold. Many real estate agents find it necessary to hire assistants simply to manage the large volumes of information necessary to process a day's leads into a meaningful format that is useful in pursuing the leads.

There are several potential sources of information that a real estate agent may use to identity and cross check potential leads. Many buyers and sellers use a Multiple Listing Service (“MLS”), a standardized searchable database employed by real estate brokers or agents. Typically, sellers' agents list the properties on the MLS, and agents subscribed to that MLS may then access or otherwise use the information to help a buyer find a desired property. Currently, most active MLS listings are also available to the general public via the Internet, while expired and sold listings are not available to the general public, but only to real estate agents or brokers subscribing to the particular MLS. MLS databases are generally considered to be essential to the practice of real estate brokerage. In fact, a real estate broker who does not subscribe to an MLS generally cannot access the most complete set of information about each property that is available to other brokers. The non-subscribing broker also cannot input information into the MLS. Historically, however, MLSs have not served as a good source for agents to identify potential leads, in part because of the aforementioned restriction on soliciting clients from current agents. In addition, although MLSs combine their various listings into a standard format within each MLS, the format may not be standard between different MLSs, which may cause problems for agents needing to access multiple MLSs for information

Because access to an MLS is often limited to participating brokers (generally those who are subscribing MLS members and members of either the National Association of Realtors (“MAR”) or the Canadian Real Estate Association (“CREA”)), people selling their property without a broker generally cannot place their listing directly into an MLS. In some instances, these “for sale by owner” (“FSBO”) sellers may list their property on alternate listings, often known as FSBO listings. FSBO sellers are important potential leads for agents, as many FSBO sellers encounter difficulties in selling their properties and so may be more amenable to listing a property after not having success selling it themselves. According to the NAR, approximately 83% of FSBO sellers eventually use an agent to list their properties. Agents encounter many difficulties in timely identifying these leads, however, because of the varying listing services for FSBO sellers, and because an agent must use caution to ensure that the agent does not contact a FSBO seller that has already agreed to be exclusively listed by another agent.

There are many other important potential sources for leads at the disposal of real estate agents or brokers. However, each includes additional different sources of information with information in different formats. The complexity of searching through these additional sources serves as a significant barrier to effectively using these other sources as potential leads. These sources include databases of foreclosures or of pre-foreclosures/notices of default. In addition, other potential sources of information useful in discovering leads have not been utilized or have been underutilized by agents because of the complexity required to use these sources.

Although the MLS system has many advantages, it is lacking in several respects. First, the MLS system often lacks information about FSBO properties. Second, as discussed above, because there are multiple MLSs and each is owned and governed by a private entity or entities, not all MLSs have property information in the same format nor have the exact same rules for participation. Third, as it pertains to potential leads for real estate agents, the information in a MLS listing may be incomplete or incorrect: MLS listings do not include information about when a listing will expire (and thus, when the seller may be contacted by a new agent), and a listing real estate agent may list incorrect owner information in a MLS listing or may not list it at all in an attempt to prevent competing agents from using the information to contact the clients.

Thus, although it is generally well known among real estate agents that listings that have expired from the MLS—in other words, properties that have not sold within the time frame of the seller's listing agreement with the agent—are potentially valuable “leads,” significant hurdles exist in using this information. Also, as discussed above, FSBO properties and pending foreclosures are also considered valuable leads that have barriers for use. In other words, a real estate agent may find it profitable to attempt to contact owners of expired listings, FSBO properties, or pending foreclosures, etc., and try to convince these owners to list with the agent. However, finding information on such properties is time-consuming because there is no central source of contact information of owners of such properties. For example, a search or query for expired listings can be performed on the MLS, but generally the resulting list of expired listings (also sometimes referred to as “expireds”) no longer includes (or never included) key information such as the property owner's contact information. Thus, agents or brokers seeking to use expireds listings on the MLS as a source of leads must do additional searches to determine owner information.

Moreover, sometimes a property flagged as “expired” on an MLS (or a property in a FSBO or foreclosure database) has in fact already been re-listed (or listed) with another agent. Therefore, an agent seeking to use these sources as potential leads must generally supplement his or her MLS/FSBO/foreclosure query with a manual search for additional information for each individual property. Such manual searching—which sometimes includes searching among sources available on the Internet and among paper-based phone directories or other specialized directories—is extremely inefficient and time consuming for the agent. In addition, the advent of federal, state, and personal “do not call” lists has further complicated the situation by requiring that agents check every potential lead against one or more do not call lists to ensure compliance with laws and regulations.

### BRIEF SUMMARY OF THE INVENTION

Embodiments of methods and systems of the present invention provide computer-implemented methods and systems for retrieving potential real estate leads. The real estate leads may include one or more of active MLS listings, expired MLS listings, FSBOs, foreclosures, pre-foreclosures/notices of default, just listed/just sold databases, sphere of influence leads, etc.

In some embodiments of the present invention, expired listings, FSBOs, foreclosures, pre-foreclosures/notices of default, and/or other leads are automatically updated when a property is sold or listed with a real estate agent. One means of accomplishing this is by scanning active MLS listings and tax records.

Also, in some embodiments of the present invention, missing data, specifically owner information and owner contact information, is identified and completed where possible. Moreover, in some embodiments, the systems and methods search for and supplement, the leads and owner information with supplemental information such as property tax data, population demographics, recent comparable sales in the area, etc., at the discretion of the agent.

The present invention offers a valuable tool to the art of real estate brokerage. The embodiments of the present invention provide powerful automated searching features that search quickly and comprehensively and that effectively provide near-instant, real-time, up-to-date information on potential leads. In some embodiments of the present invention, additional management tools are available for the convenience of the user. The methods and systems of the present invention save time, money, and have the potential to significantly add to a real estate professional's bottom line.

### BRIEF DESCRIPTION OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer-based system that provides a suitable operating environment for some embodiments of the present invention;

FIG. 2A shows a schematic block diagram in accordance with some embodiments of

the present invention, and FIG. 2B shows a flowchart in accordance with some embodiments of the present invention;

FIG. 3A illustrates an example of a main screen displayed upon entry in an interface in accordance with some embodiments of the present invention;

FIGS. 3B and 3C show examples of notifications and actions that may be taken by some embodiments of the present invention;

FIGS. 3D and 3E show sample results of actions taken by some embodiments of the present invention;

FIGS. 4A and 4B, respectively, show an example of an electronic display of expired listings and an electronic display of detailed information on a particular expired listing in accordance with some embodiments of the present invention;

FIG. 5 shows a sample interface by which a user can add a task relating to a real estate property in accordance with some embodiments of the present invention;

FIG. 6 illustrates an example of a sample telephone script that a real estate agent may use when contacting an owner of a real estate property found in accordance with some embodiments of the present invention;

FIG. 7 shows an example of a mail merge feature available in some embodiments of the present invention; and

FIGS. 8A-8C show sample screen shots of a profiling function in accordance with some embodiments of the present invention.

### DETAILED DESCRIPTION OF EMBODIMENTS OF THE INVENTION

A description of embodiments of the present invention will be given with reference to the Figures. It is expected that the present invention may take many other forms and shapes; hence the following description is merely intended to be illustrative, and the scope of the invention should be determined by reference to the appended claims.

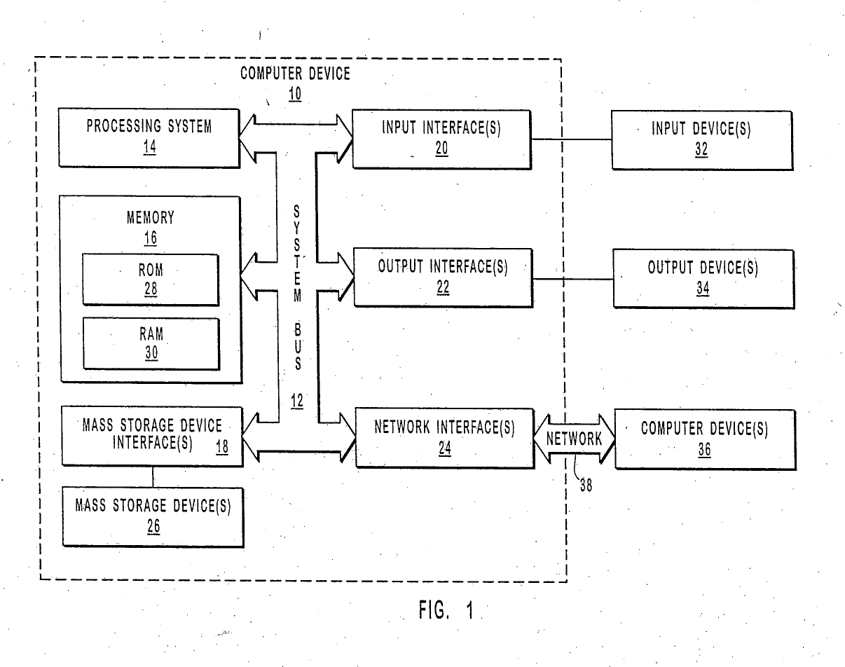

FIG. 1 and the corresponding discussion are intended to provide a general description of a computer-based environment: one suitable operating environment in which the invention may be implemented. One skilled in the art will appreciate that the invention may incorporate one or more computer devices in a variety of system configurations, including a variety of network-based configurations. Also, embodiments of the present invention may embrace one or more computer-readable media configured to include or potentially include thereon data or computer executable instructions for manipulating data. Computer executable instructions—for example, software code, data structures, objects, programs, routines, program modules, etc.—cause one or more computer devices to perform one or more functions and comprise one type of means for implementing the methods or steps of embodiments of the present invention. Examples of computer-readable media include various types of random-access memory (“RAM”) media, read-only memory (“ROM”) media, compact disks (“CDs”), digital video disks (“DVDs”), hard drives, memory sticks, floppy disks, an electronic signal, or any other device or component that is capable of providing data or executable instructions for a computer device Electronic signals are typically embodied in a light medium or carrier wave.

With reference to FIG. 1, a representative system for implementing the invention may include computer device 10, which may be a general-purpose or special-purpose computer. For example, computer device 10 may be a personal computer, a notebook computer, a personal digital assistant (“PDA”) or other hand-held electronic device, a cell phone, a hand-held MP3 player, a workstation, a minicomputer, a mainframe, a supercomputer, a multi-processor system, a network computer, a processor-based consumer electronic device, etc. The term “computer device” herein is used generally and may refer either to a single computer device or to multiple computer devices, whether stand-alone or networked.

Computer device 10 may include a system bus 12, which may be configured to connect various components of the computer device 10 and may enable data to be exchanged between the components. System bus 12 may include one of a variety of bus structures including a memory bus or memory controller, a peripheral bus, or a local bus that uses any of a variety of bus architectures. Typical components connected by system bus 12 may include a processing system 14 and memory 16. Other components may include one or more mass storage device interfaces 18, input interfaces 20, output interfaces 22, and/or network interfaces 24.

Processing system 14 may include one or more processors, such as a central processor and optionally one or more other processors designed to perform a particular function or task. It is typically processing system 14 that executes computer-readable instructions found in memory 16, which in turn may be embodied in computer-readable media such as RAM or ROM media, magnetic hard disks, removable magnetic disks, magnetic cassettes, optical disks, etc.

Memory 16 may be embodied in one or more computer-readable media that may be configured to include thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, software applications, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives, and optical disk drives. A mass storage device 26 may read from and/or write to a magnetic hard disk, a removable magnetic disk, a magnetic cassette, an optical disk, or other computer-readable medium. Mass storage devices 26 and their corresponding computer-readable media may provide nonvolatile storage of data and/or executable instructions that may include one or more program modules such as an operating system, one or more software applications, program modules, program data, etc. Such executable instructions are examples of means for implementing steps or methods disclosed herein.

One or more input interfaces 20 may be employed to enable a user to enter data and/or instructions to computer device 10 through one or more corresponding input devices 32. Examples of such input devices include but are not limited to: a keyboard, a mouse, a trackball, a touch screen, a light pen, a stylus or other pointing device, a microphone, a joystick, a game pad, a satellite dish, a scanner, a camcorder, a digital camera, etc. Examples of input interfaces 20 that may be used to connect the input devices 32 to the system bus 12 include a serial port, a parallel port, a game port, a universal serial bus (“USB”) port, a firewire (IEEE 1394), etc.

One or more output interfaces 22 may be employed to connect one or more corresponding output devices 34 to system bus 12. Examples of output devices include a monitor or display screen, a speaker, a printer, etc. A particular output device 34 may be integrated with or be peripheral to computer device 10. Examples of output interfaces 22 include a video adapter, an audio adapter, a parallel port, etc.

One or more network interfaces 24 may enable computer device 10 to exchange information with one or more other local or remote computer devices, illustrated generally at 36, via a network 38 that may include wired and/or wireless connections. Examples of network interfaces 24 include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system, computer device 10 may participate in a distributed computing environment, where functions or tasks are performed by a plurality of networked computer devices.

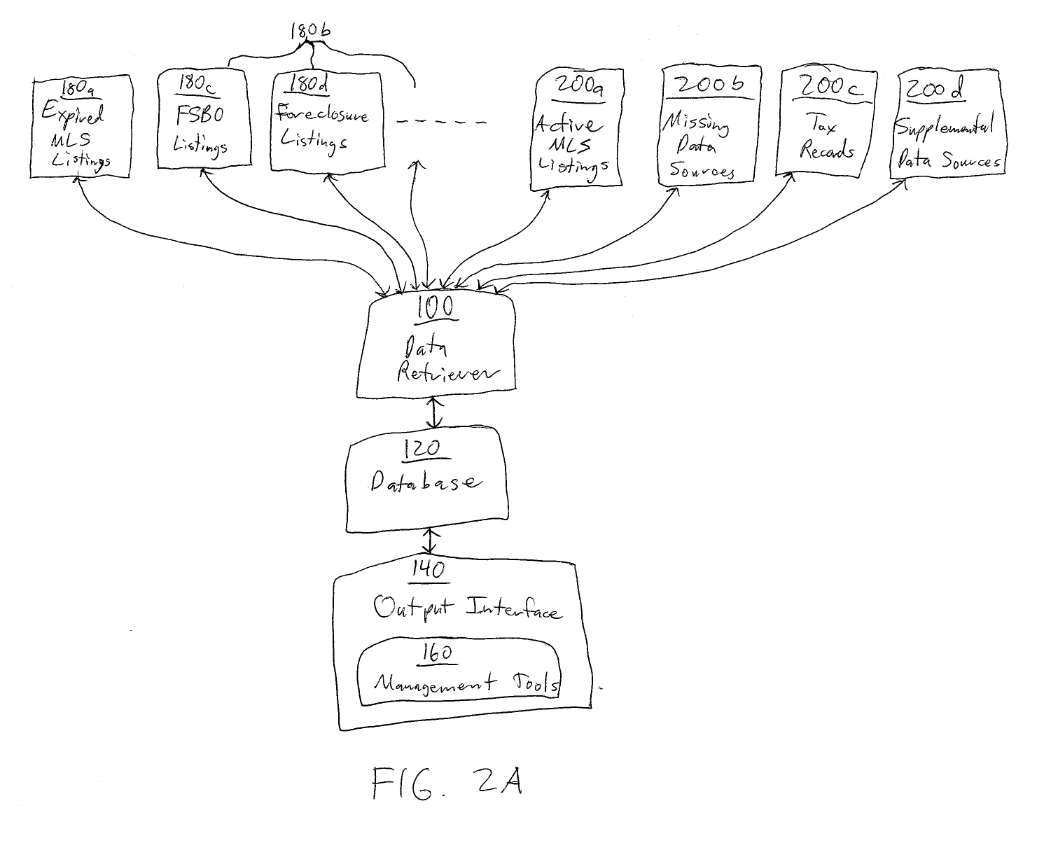

While those skilled in the art will appreciate that embodiments of the present invention may be practiced via various types of computer system configurations, FIG. 2A shows a schematic block diagram illustrating a data or information retriever 100, a database 120, and an output interface 140 with optional management tools 160.

Data retriever 100 includes software or computer-executable instructions on computer-readable media, the software providing for automatic searching and retrieval of electronic data. The data retriever 100 may include one or more downloadable client-based software modules that an authorized user may download from a web site, but the data retriever 100 may be embodied in any suitable computer-implemented system. Using a downloadable client-based software module and a local database 120 provides an advantage in that it complies with the current requirement of most MLS listing services that exported information from the MLSs may only be used on agents' own computer systems and may not be located on third-party web-based servers available to multiple agents or clients. In other words, it complies with the MLS requirements designed to prevent third parties from scraping the data contained in the MLS databases and making it available to non-subscribers who have not paid the fees required to access the MLS information. Other embodiments of the current invention embrace providing such updates on an Internet-based/web-based system in compliance with MLS rates. Such a system could be in compliance with MLS rules if currently-typical MLS subscription rules were changed to permit remote third-party storage/retrieval of MLS-downloaded information. Alternatively, such a system could be in compliance with MLS rules through a special license arrangement or written agreement with a particular MLS or MLSs in general to permit off-site storage/retrieval of information. Thus, although a downloadable client-based software module is currently viewed as advantageous for complying with currently-typical MLS term of use regulations, the current invention also embraces on-line and remote storage and access of MLS and other information listings.

In one embodiment, data retriever 100 imports information comprising at least one potential real estate lead from a source of expired MLS listings 180a and/or optionally from other sources 180b as well. The expired MLS listings (“expireds”) 180a may be retrieved via a subscription to the MLS using MLS-provided export features, for example. This may be done using search results resulting from a query made on the MLS by a subscriber to that MLS. Alternatively, in some embodiments the information may be retrieved from a source other than the MLS. This may be done, for example, when the data retriever 100 imports data exclusively from non-MLS sources 180b such as FSBO listings 180c. It shall be noted that the term “MLS” herein may refer to a single MLS or may refer generally to a group of MLS databases, including generally to the entire MLS system.

The other sources 180b may include FSBOs listings 180c, foreclosure listings 180d, sold MLS listings (not shown), pre-foreclosure listings/notices of default (not shown), 1-800 number sign call leads (not shown), or any other potential real estate leads. These other sources 180b may include any source available in an electronic format, including sources generally available on the Internet or third party lead sources that compile lists of potential real estate property leads. Example of these third-party lead sources may include but are not limited to: Warnock's By Owner™, Landvoice™, Arch Telecom™, Realty Trac™, FSBOTrac™, ByOwnerDaily™, etc.

In some embodiments of the present invention, the data retriever 100 also searches active MLS listings 200a and sold MLS listings (not shown) to ensure that the potential leads discovered from the sources 180 have not been sold or listed/re-listed with another real estate agent. This ensures that the expireds drawn from the expired MLS listings 180a are in fact still expired, that FSBO listings are still FSBOs, etc. The data retriever 100 may also search active MLS listings 200a and any of sources 180 to update other information retrieved from the sources 180. In some embodiments of the present invention, a computer device 10 automatically screens all leads/potential leads on a periodic basis (for example, daily) to determine whether the expired listings are still expired, FSBO listings are still FSBOs, etc., thereby allowing for the provision of current, real-time listing and lead data. In some embodiments, the computer device 10 automatically screens one or more of the following: expired listings, FSBOs, foreclosure properties, or any other property lead. Moreover, in some embodiments, the user is automatically notified if a property is sold or is listed in an MLS.

As discussed above, determining that a potential lead has not been sold or listed/re-listed by another agent is often only one step in identifying and preparing leads for pursuit and solicitation by a real estate agent. Therefore, in some embodiments of the present invention, the data retriever 100 also identifies missing or incorrect owner information in the potential lead obtained from the sources 180, and the data retriever 100 also searches electronic sources in order to supplement or “fill-in” the missing information for the collected real estate leads. The data retriever 100 may search to identify the owner and additionally for owner contact information in missing data sources 200b such as missing phone numbers and mailing addresses, etc. The missing data sources 200b in which data retriever 100 may search include the initial sources searched (MLS, FSBO, foreclosure databases, etc.), or it may search additional electronic sources such as electronic directories provided by third parties and tax records.

In some embodiments, the data retriever 100 also searches local tax records 200c for the “last sold date” and/or the mailing address of the property identified as a lead/potential lead. Typical MLS systems rely on the listing agents to update the status of the property on the MLS listing/expired listing to tell people the property has sold. Some agents neglect to do this, resulting in potential leads that are not valid leads. A real estate agent relying on the potential lead without first confirming that the property has not been sold may be embarrassed to discover on soliciting the lead that the property has been sold. In searching through the tax records 200c for the last sold date, some embodiments of the present invention identify invalid leads by identifying leads having a last sold date that postdates the list date of the property. Additionally, in searching the tax records 200c for the mailing address of the property identified as a lead/potential lead, some embodiments are able to identify non-owner-occupied properties. Typically, a real estate agent wishes to identify the owner of a property, not the resident or occupant of the property. This may be particularly useful in resort towns, or for instances where an owner has several homes or investment properties. Although described above in relation to expireds, this method may also be used for FSBO leads and other leads discussed above where the sold data contained in the lead source 180 may be out of date.

When such searches are performed in tax records 200c and other sources 180, 200, it is beneficial to ensure that all addresses (property addresses and mailing addresses) are formatted into a standard format, such as the standard format typically used by the United States Postal Service. This ensures that potential address matches are not missed when one source 180, 200 lists an address as 185 South Dakota Avenue, another lists it as 185 S. Dakota Avenue, and another lists the same address as 185 S. Dakota Ave. One of skill in the art will recognize the wide variety of address variations that may be encountered in searching various sources 180, 200, and will further recognize the value of standardizing the addresses. Therefore, in some embodiments of the invention, the data retriever 100, or an associated program, standardizes any addresses retrieved from sources 180, 200 according to a standardization tool, such as a U.S. Postal Service standardization tool. In some embodiments, the standardization may occur automatically, and the user need not provide any input. In other embodiments, the standardization may occur automatically, with the user notified if an address cannot be standardized from its current format. In still other embodiments, the system may notify the real estate agent of potential close address matches from varying sources 180, 200 that still do not perfectly match after address standardization has occurred. Address standardization may he a selectively operable tool, so the real estate agent may select to standardize addresses, or may choose to review addresses in the format encountered in the sources 180, 200.

Also, in some embodiments of the present invention, the data retriever 100 may search supplemental sources 200d to retrieve supplemental data for the collected real estate leads, at the discretion or command of the real estate agent. Examples of such supplemental data may include but are not limited to information relating to: property taxes, schools, population demographics, sales history of the property, comparable sales in the area, whether a phone number is on the National “Do-Not-Call” registry, environmental hazard reports, and/or anything that a real estate agent or potential buyer or seller may want to know about a property. Again, the data retriever 100 may search the initial sources 180 searched, or it may search additional electronic sources not previously searched. The supplemental information received may be used for additional reports and/or actions as will be described in detail hereinafter.

The data retriever 100 searches for and retrieves the information or data by any suitable means; however, the data retriever 100 commonly retrieves the data via a method or means in compliance with the terms of use of the MLS or other system serving as a source 180, 200 of the data. For MLS systems, this means that the data retriever 100 utilizes the MLS systems' export features and directly downloads the information from the MLS system to the agent's computer, rather than being stored on a third-party computer system. Since the data obtained from the various sources 180 may not all be in the same format or in a format compatible with the desirable format for searching/viewing used by the real estate agent, the data retriever 100 or another program on the computer containing the data retriever 100 may reformat/standardize the obtained information. Thus, the information may be profiled into a standard format regardless of source which makes it more easily accessible to the real estate agent pursuing leads and to the data retriever 100 as the data retriever 100 seeks the additional information from sources 180, 200 described above. The data for each real estate property includes a subset of data that may include any variety of information, including but not limited to: property address, owner name and contact information, property sales history, property tax history, photos of the property, etc.

To profile the received information, a profiler program (the data retriever 100 or other program performing the standardizing of the data format) may map the data source 180 acting as a lead source or the additional information source 200 to link information from the data source 180, 200 to the corresponding data field used by the database 120 and the data retriever 100 on the agent's computer systems). This mapping may be done on an initial retrieval of information from the data source 180 or information source 200. In some embodiments, the initial mapping may be done manually, with the agent or other user manually selecting which fields of imported data correspond to selected fields used by the data retriever 100 and database 120. In other embodiments, the profiler program may intelligently map the data source 180, 200, such as by using the source database field descriptors or by searching for meaningful source information to identity the proper fields. Once the initial mapping has been done, later imports from a particular source 180, 200 may be easily profiled to the standardized format used by the data retriever 100 and database 120. This allows embodiments of the Invention to perform bulk imports and rapid processing and updating of large amounts of data, providing the real estate agent with a large number of potential leads in an automated fashion while complying with MLS and other term of use rules.

All the information or data collected may be placed in a database 120, often a central database located on a client computer device 100 (as necessary to comply with any MLS or other terms of use agreements agreed to by the real estate agent). In some embodiments, the database 120 may be embodied in a variety of forms, may reside on a plurality of computer-readable media, and may reside in whole or in part on a local or remote computer device or network, to the extent any terms of use agreements permit such storage. Thus, if a particular MLS or group of MLSs allowed off-site, web-based, and/or third-party storage of exported MLS information, whether by contract or rule change, some embodiments of the invention embrace such storage mechanisms.

In order to access the information in the database 120, a user may use the output interface 140. The output interface 140 allows the user to view the data in an organized fashion and may also provide management tools 160 to help the user use the data more efficiently. Exemplary embodiments of management tools 160 and the output interface 140 will be described in further detail hereinafter.

FIG. 28 shows a flowchart illustrating steps or methods in accordance with some embodiments of the present invention. First, a computer device 10 or portion thereof collects or retrieves an initial set of data 300 that includes potential leads. Examples of an initial set of data include but are not limited to: active MLS listings, sold MLS listings, expired MLS listings, foreclosure listings, pre-foreclosure listings/notices of default, FSBO listings, 1-800 sign call leads, etc. Next, in some embodiments of the present invention, the computer device 10 updates the potential leads, in some instances automatically on a periodic basis, by comparing them with active MLS listings and sold MLS listings 310 to determine if any potential leads are invalid leads because the property has been sold or listed/re-listed with another agent. In some embodiments, the computer device 10 also updates the potential leads to determine if any potential leads are invalid leads by checking the tax records 320 to determine if any potential leads have a last sold date that postdates the most recent listing date.

Also, in some embodiments of the present invention, the computer device 10 searches for and finds missing data 330 such as missing owner information and missing owner contact information. In other words, the computer devices 10 “completes” the missing data wherever possible by searching electronic sources, such as tax records, electronic phone listings, expired listings, etc. In some embodiments, the computer device 10 also checks existing owner data to ensure that the data correctly reflects actual owner data. For example, the computer device 10 may search active MLS listings or other expired MLS listings to determine if other listings contain identical contact information. This may be the case, for example, when the original real estate agent always uses his/her own telephone number or other contact information on the MLS listings. Such a search may identify such repetitions and prevent a wasteful call to another real estate agent that was intended to be directed to an owner. Some embodiments of the invention may also accomplish this by maintaining a database of known real estate agent contact information to flag as incorrect owner information.

In some embodiments of the present invention, the computer device 10 supplements the collected data 340 with additional data from various electronic sources. Such additional data may include but is not limited to: property taxes, schools, population demographics, sales history of the property, whether a phone number is on the National “Do-Not-Call” registry, environmental hazard reports, and/or anything that a real estate agent or potential buyer or seller may want to know about a property. For example, if an agent learns that an owner of a particular potential lead has a number listed on a “Do-Not-Call” registry or list, the agent may use this information to tailor his/her approach to soliciting the potential client to focus on mailings without any phone solicitations.

The computer device 10 places all information or data collected into a database 350. The data may be collected by any means discussed above or known in the art, typically using methods and means in compliance with any terms of use agreements governing access to the information contained in the electronic information sources. In some embodiments, the user is a subscribed to an MLS and information retrieved from the MLS is obtained using MLS-provided export features; however, other embodiments contemplate users who are not subscribers to any MLS but that may have access to other legitimate sources of potential lead data. As noted in FIG. 2B, the data is output to a user 350. Examples of methods of such outputs shall be described hereinafter.

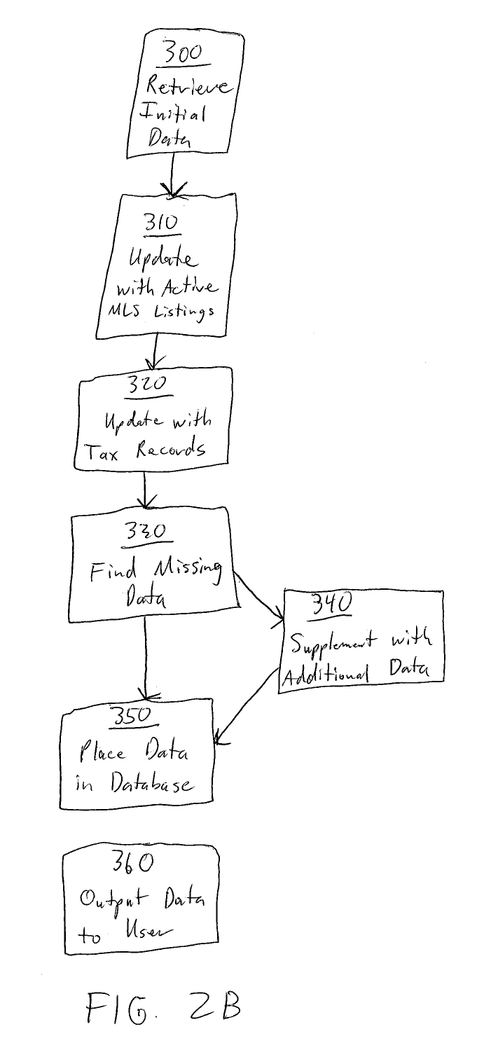

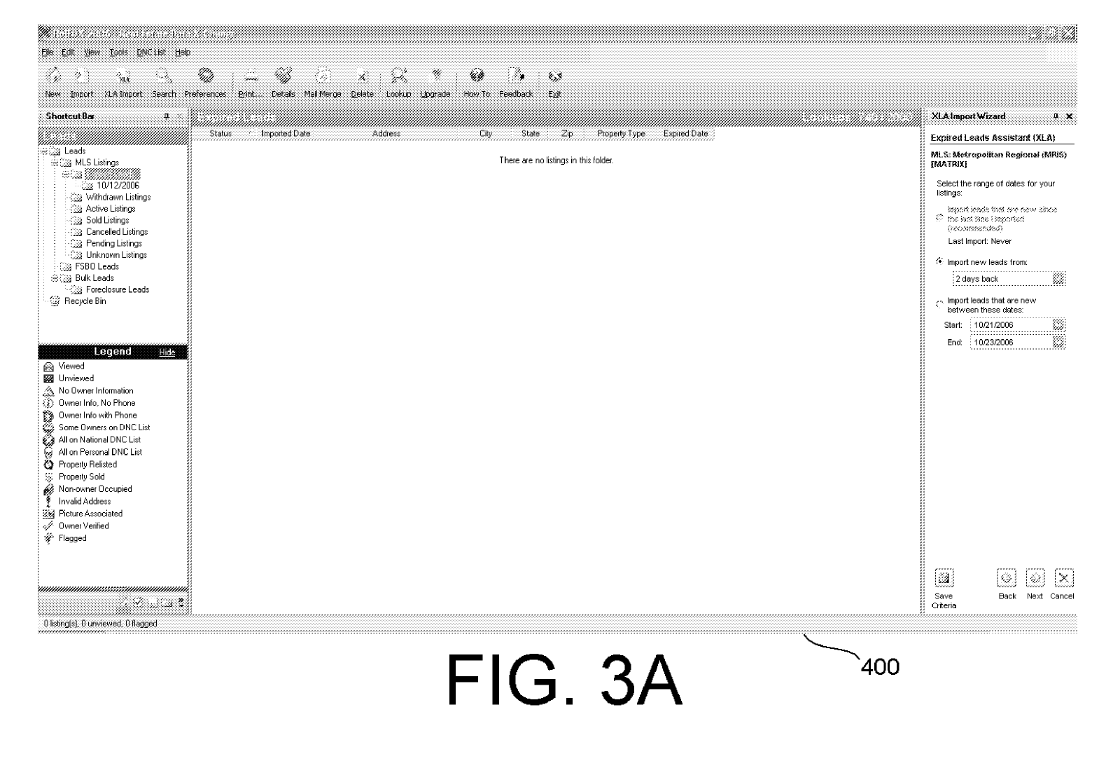

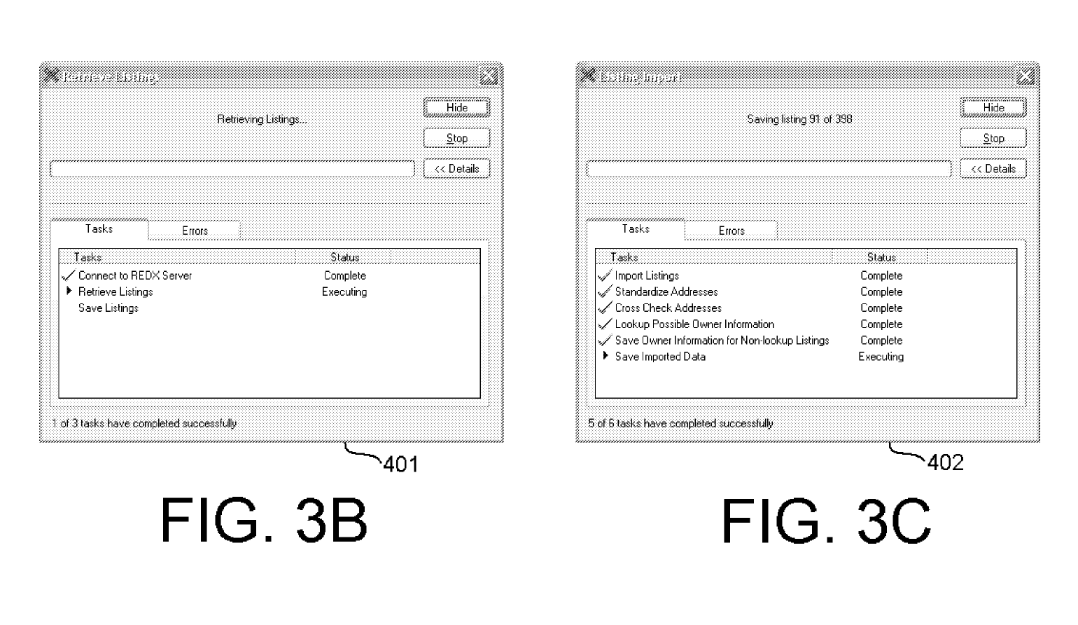

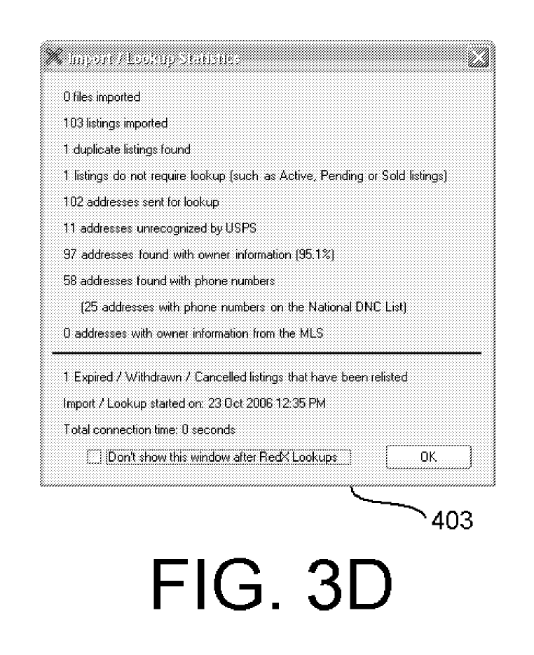

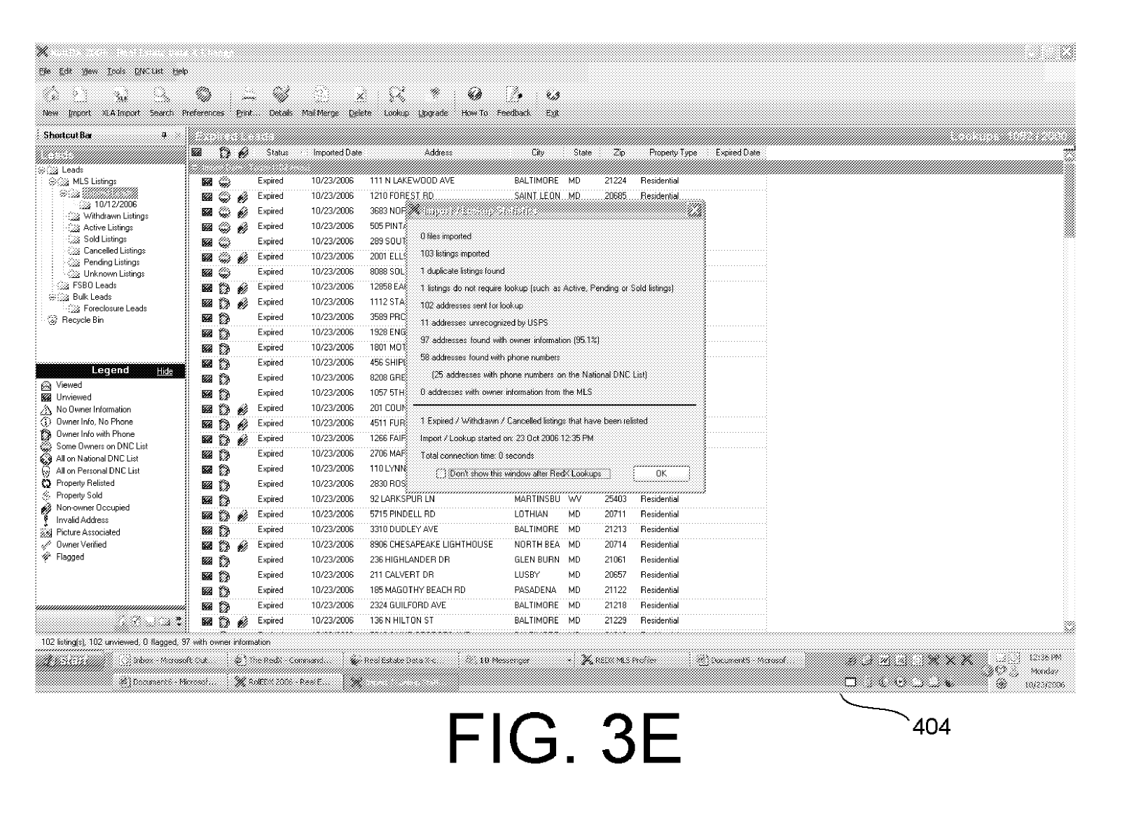

FIG. 3A illustrates an example of a main screen displayed upon entry in an interface 400 in accordance with some embodiments of the present invention. In this interface, the user may view a main menu from which the user can choose to have a computer device 10 perform various tasks, including: importing data from the MLS and from other sources such as FSBO sources; viewing the imported listings, performing a mail merge using the imported data, scheduling tasks, etc. FIGS. 3B and 3C show notifications 401, 402 that may be displayed to a real estate agent using some embodiments of the present invention as leads are retrieved (FIG. 3B) and as information from the retrieved leads is imported, standardized, checked, and supplemented (FIG. 3C). FIGS. 3D and 3E show one example 403 of possible results of the actions depicted in FIGS. 3B and 3C, and the change 404 in the display of FIG. 3A based on the results, respectively.

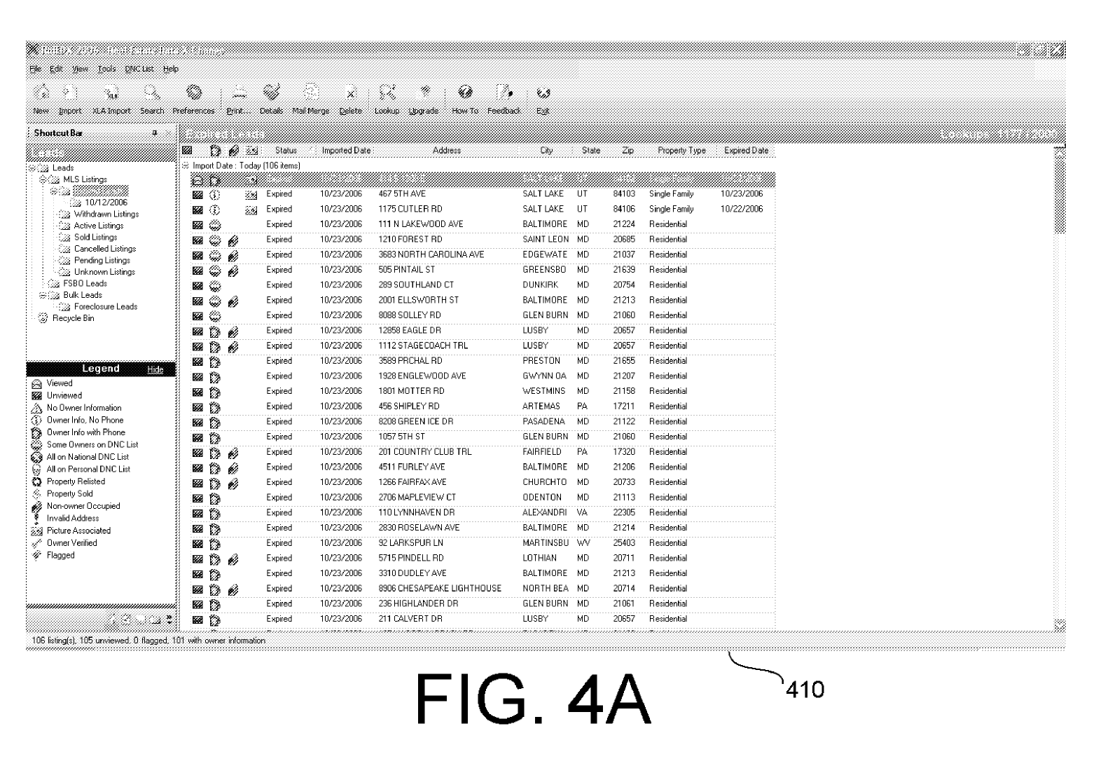

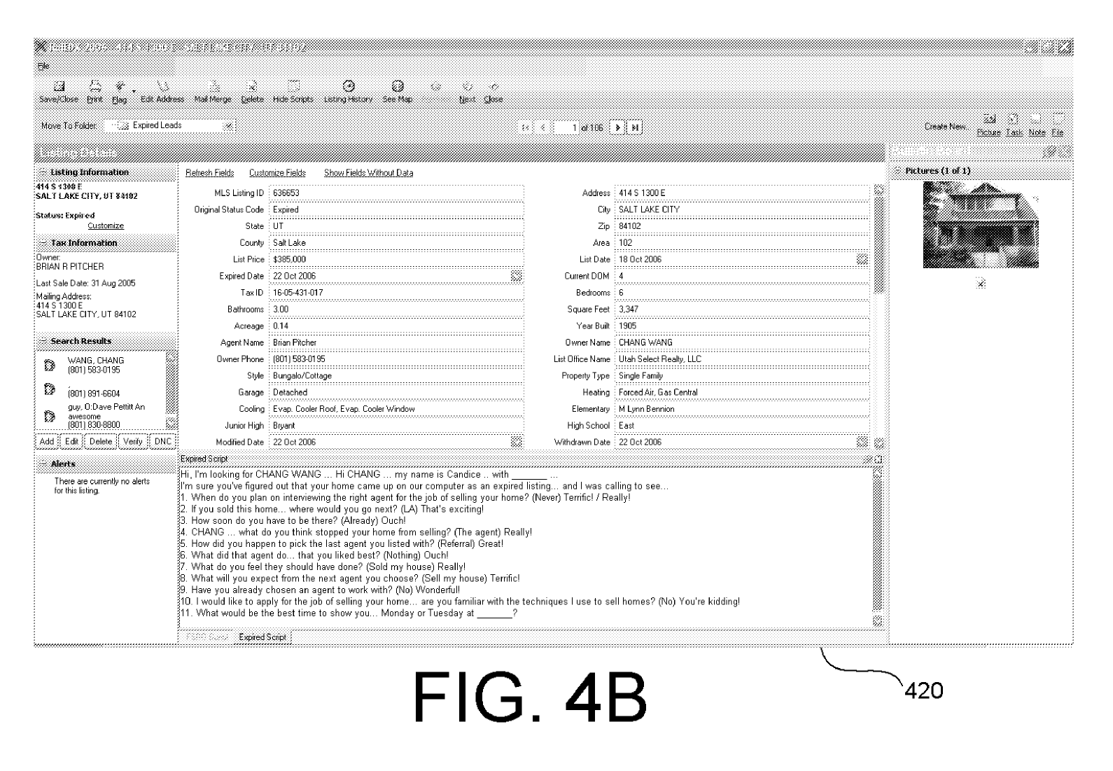

FIG. 4A illustrates an example of a user interface 410 displaying expired listings imported from an MLS.

FIG. 4B shows a sample user interface 420 showing detailed information on a particular expired listing from among the listings shown in FIG. 4A. In some embodiments of the present invention, the user can do one or more of the following: add a reminder to call the owner of a particular listing on a certain day, set an appointment regarding the listing, make notes linked to the listing, edit the details and change the pictures for the listing, print the listing, etc. These actions may be taken for any lead or potential lead, regardless of the original source.

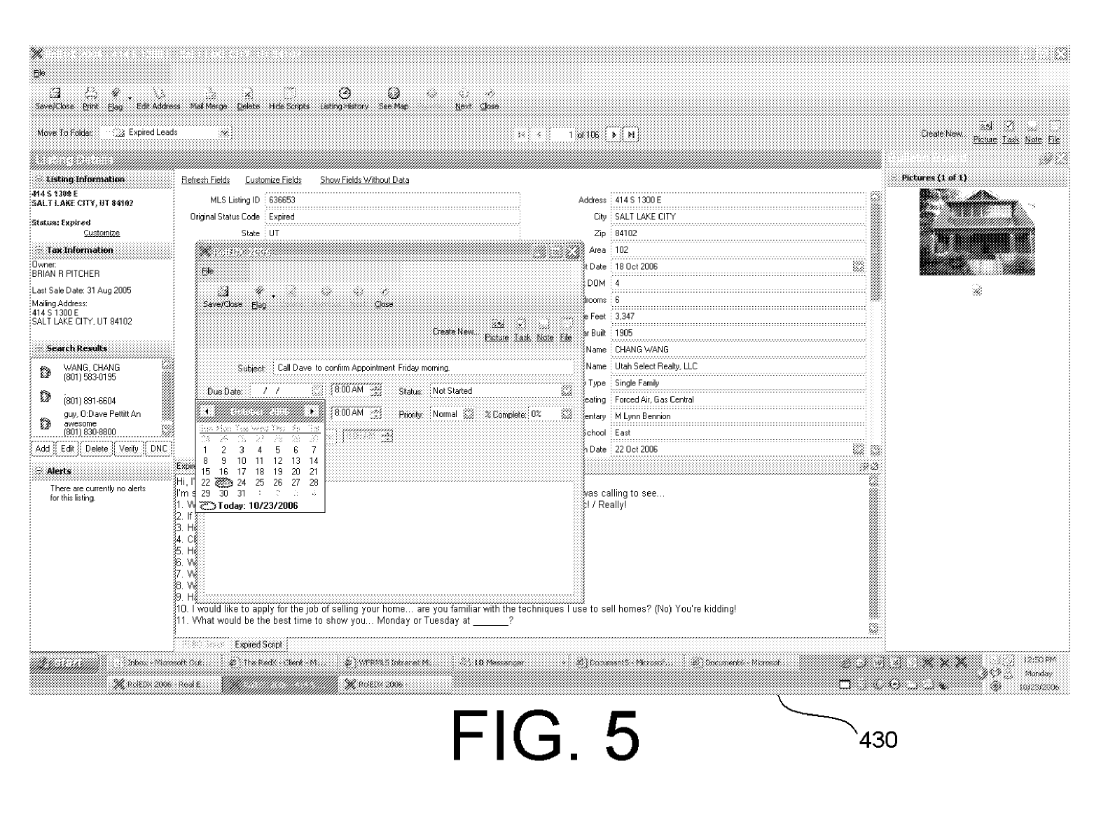

FIG. 5 shows a sample interface 430 by which a user can add a task relating to the listing of FIG. 4B. As shown, some embodiments of the present invention offer task-creating or scheduling tools to further aid the user in utilizing or managing the data. Some embodiments of the invention include management tools that include full tasking/calendaring capabilities, full contact and e-mail management capabilities, and other helpful management capabilities. For example, some embodiments of the invention include mail management features such as a link to an external mail fulfillment center that allows a user to select a number of leads to receive a particular mailer and automatically sends the request to the external mail fulfillment center for processing.

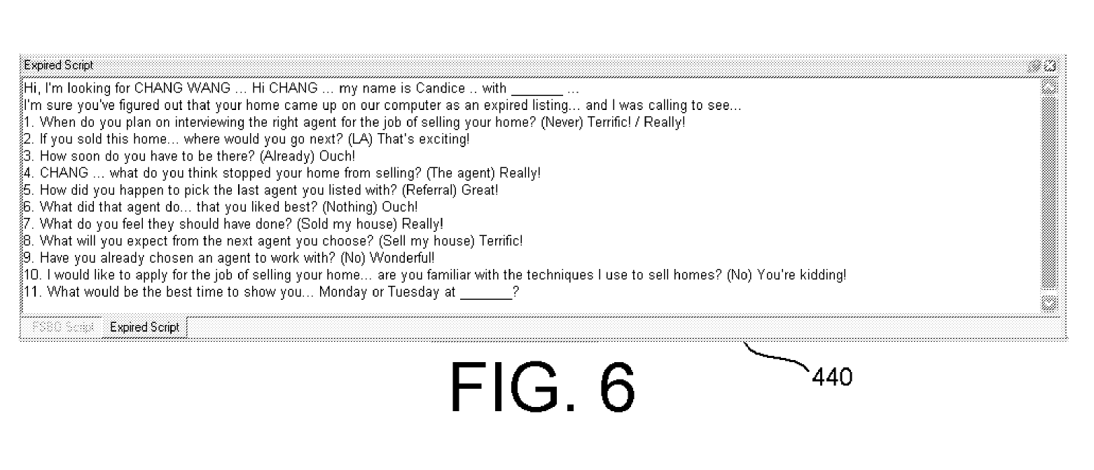

FIG. 6 illustrates an example of an interface 440 displaying a sample telephone script that a real estate agent may use when contacting the owner of a listing such as the listing of FIG. 4B. In some embodiments, the user may use a default telephone script provided on the interface, or the user may custom create his/her own script. The call scripting feature is another example of a management tool that is designed to aid the user in utilizing or managing the data.

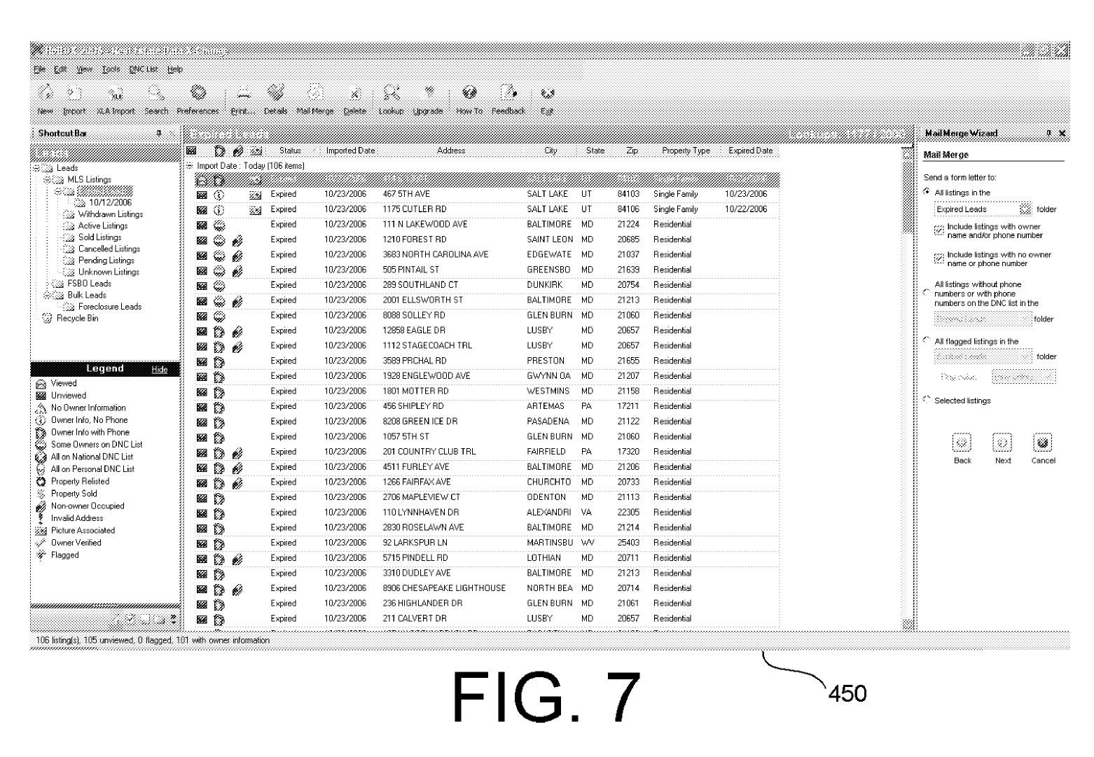

FIG. 7 shows an interface 450 displaying an example of a mail merge feature, yet another management tool available in some embodiments of the present invention. The mail merge feature, which is not limited to the specific embodiment shown here, allows the user to quickly use the imported mailing addresses to mass mail letters using a form letter or a custom-created letter. This mail merge feature is particularly convenient if the systems of the present invention are unable to find owner telephone contact information for one or more real estate properties. Some embodiments of the invention include e-mail merge functions similar in fashion to the mail merge function shown in FIG. 7. Other embodiments may provide a link to an external mail fulfillment facility that handles mailings or mass mailings for the real estate agent, freeing the agent to pursue other forms of lead acquisition.

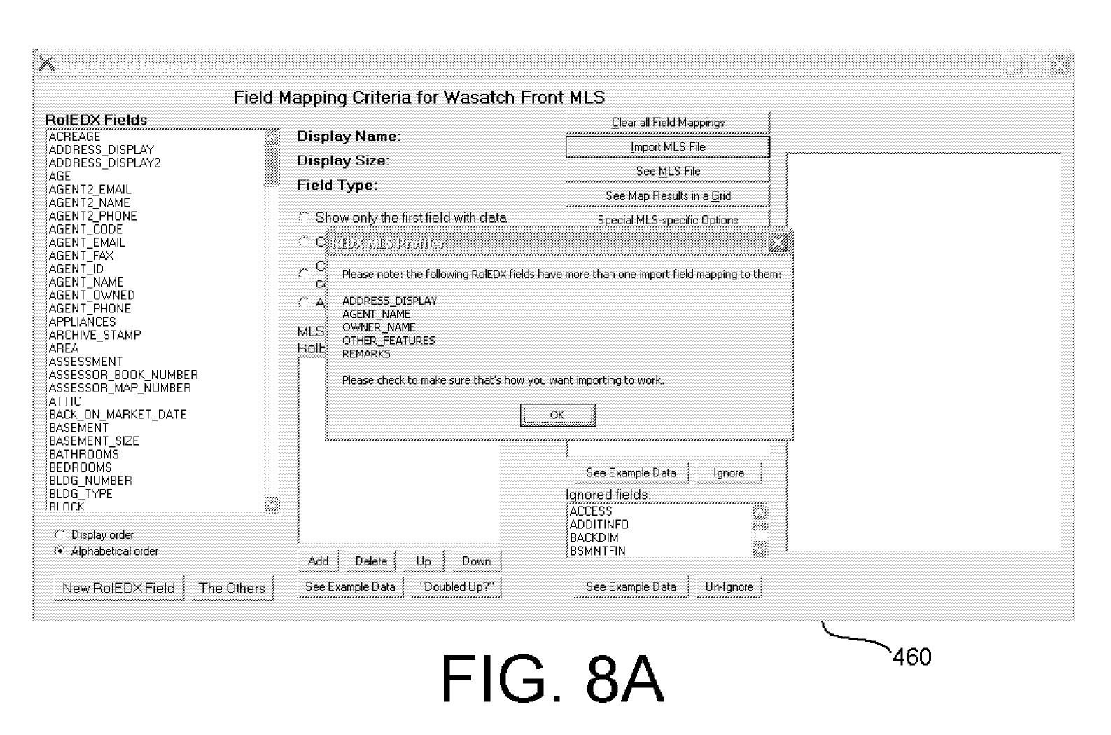

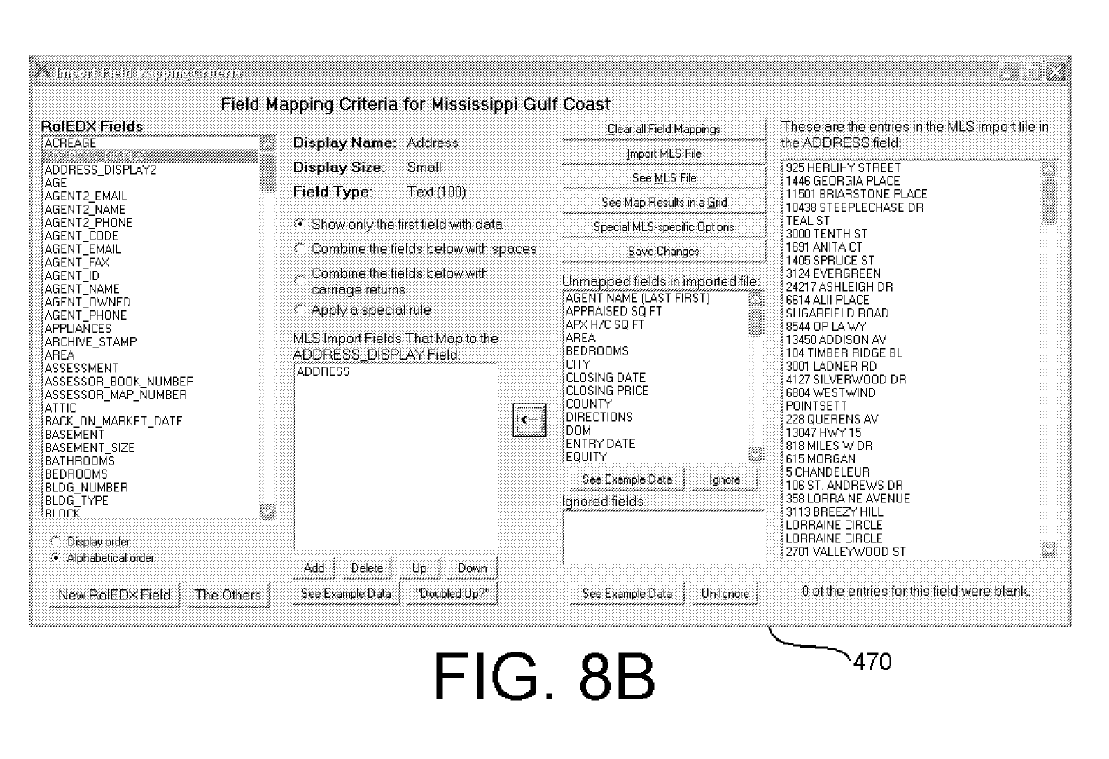

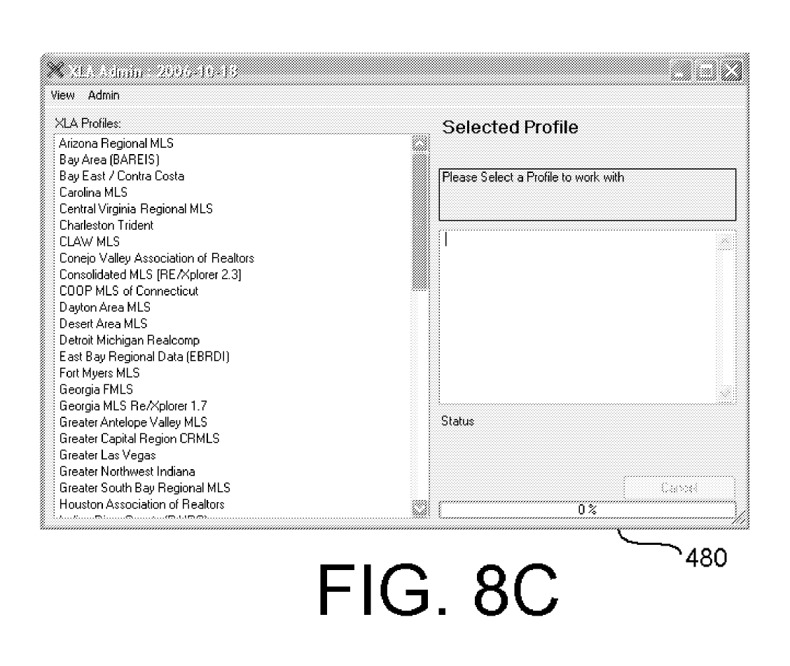

FIG. 8A shows one example of a screen shot 460 of a profiling function that may be presented in accordance with some embodiments of the present invention. FIG. 8B shows an example of a screen shot 470 that may be displayed in the profiling function or program as the various fields from the data source 180, 200 are mapped into corresponding fields in a real estate lead management database on the user's computer, as discussed above. Once data mapping/profiling has occurred, the user may be provided with a screen shot similar to the screen shot 480 depicted in FIG. 8C, which allows a user to select an already-mapped profile for use in importing data from a data source 180, 200.

Other convenient features and management tools may be included in embodiments of the present invention. For example, referring to FIG. 3D, phone numbers that are on the national “Do-Not-Call” list or a personal do-not-call list imported by the individual agent may be flagged so that real estate agents or their assistants immediately know not to call those numbers.

Returning now to the cross-checking features available in some embodiments of the present invention, as described with reference to FIG. 2A, some embodiments allow cross checking of any listing data type against any data source 180, 200. For example, active listings may be cross-checked against FSBO listings 180c. In addition, active listings may be cross-checked against expired MLS listings 180a, foreclosure listings 180d, and any other type of listing 180b. This provides validation of the leads so checked.

In addition, some embodiments of the present invention allow additional cross-checking of sources 180, 200 to provide additional leads for real estate agents. For example, although “just listed” and “just sold” databases have typically not been used as a source of leads in the past, embodiments of the present invention allow these sources to act as new lead sources. This use is facilitated by the database 120 in conjunction with the data retriever 100 and the sources 180. 200. Using some embodiments of the current invention, real estate agents are able to identify properties that have just been listed or just been sold, and perform a radius search around those properties for additional properties. The real estate agent is then able to send out mailers or work with a mail fulfillment software module or external mail fulfillment center to send out mailers or other solicitations, including e-mails, targeting other potential clients.

These types of searches and databases also allow the real estate agent to prepare comprehensive reports and market analyses not currently easily available. Because some embodiments of the current invention include a profiler that standardizes all available information into a readily-accessible format, the generation of such reports is facilitated. Such reports may be used as part of a mailing campaign to encourage potential clients to consider selling their real estate and to consider a particular real estate agent. Rather than merely printing off a listing of recent sales/listings and providing those to a client, a real estate agent using the current invention can provide a potential lead with detailed analyses of current sales trends, price-per-square-foot averages, average time-to-sale figures, etc, and many of these reports and facts may be provided automatically upon a single click of the agent on a report button/function of embodiments of the current invention.

Some embodiments of the invention provide mechanisms that allow the real estate agent to control the sources 180, 200 searched and the procedures for doing so. For example, in one locality, real estate agents using embodiments of the present invention may discover that searches through free tax records have historically been accurate in providing owner information, while fee-based commercial directory databases need only be used when public records fail to provide missing owner information. In such a situation, the real estate agent may set the computer system protocol to search tax records for owner information first, and only then search in commercial databases for those leads without complete owner information. Alternatively, embodiments of the invention may provide different sources for searching at different rate structures. These selection features allow the system of some embodiments of the present invention to further enhance bulk processing of large numbers of leads as the agent can select the standard methods to be used, and allow these settings to be used for all future lead batches.

Because the embodiments of the present invention include the integral use of computer systems, management tools not currently available in the art are readily available in some embodiments of the invention. For example, since identified leads are immediately an integral part of the computer system of some embodiments of the invention as soon as they are imported from the lead data source 180, 200, it is a simple matter to use management tools to schedule solicitation activities designed to convert leads into clients. For example, using some embodiments of the present invention, it is a simple matter to schedule a “drip campaign,” which is a campaign designed to provide a series of contacts to a lead until the lead eventually becomes a client. As one example, a mailer might be scheduled for deliver) on day 1, followed by an e-mail on day 5, a phone contact on day 30, a card on day 45, etc. Of course, the agent could set up any schedule desired or preferred by the agent or could use and/or modify schedules predefined in the computer system. In one embodiment, the agent could select a lead and a drip campaign schedule, and the computer system would provide automatic reminders of the selected action to be taken for the lead on the desired days. One of skill in the art will readily appreciate how such a system can greatly improve management of a large number of leads, especially in conjunction with the automatic mailing/e-mailing systems previously described.

Some embodiments of the present, invention also facilitate tapping of historically underutilized sources of leads. One of the major sources of leads for real estate agents may be termed “sphere of influence.” Sphere of influence leads rely on referrals from neighbors, friends, former clients, etc. Some embodiments of the invention allow increased tapping of this potential lead source by allowing the real estate agent to delineate the contacts that are within the agent's sphere of influence. In conjunction with a drip campaign schedule as set forth above, it is a simple matter for a real estate agent to consistently tap this source of leads even in times when the agent is busy with other matters. Such schedules of actions may be set up for any type of lead the agent has.

The database 120 of the current system in conjunction with the data retriever 100, allows further tapping of previously-untapped sources of leads. Specifically, some embodiments of the present invention allow using active listings on the MLS to be used as leads without violating the code of ethics rule against contacting actively-represented sellers. This may be done by using the database in conjunction with active MLS listings 200a and expired MLS listings 180a to predict expiration of currently-active MLS listings and target expiring listings. This targeting takes advantage of the fact that it is often the first skilled new agent to solicit a seller that obtains the seller's business, especially after the seller has had the bad experience of listing with one agent and not having success in selling the real estate.

This is accomplished by using predictive methods on the data contained in the active MLS listings 200a and the expired MLS listings 180a. The active MLS listings 200a typically do not list a date the listing will expire; however, most real estate agents tend to use a set base contract with their listings, and thus most of the agent's listings will expire after a similar term. The computer device 10 (or data retriever 100), can exploit this fact by scanning the expired MLS listings 180a to identify listing dates and expiry dates by real estate agent. An analysis can then be performed to identify the most common contract length used by the agent. For example, the analysis might indicate that four out of five of one particular agent's listings expire after 90 days, and that all of another agent's listings expire after 120 days.

This information can then be used in conjunction with the active MLS listings 200a. Once a particular real estate agent's trends are known, the computer device 10/data retriever 100 can scan the active MLS listings 200a to find listings by the particular real estate agent which are approaching the predicted expiry. Because the code of ethics allows certain types of mailers to be sent to even active clients of other agents, the system may allow these acceptable general mailers to be sent to the leads whose contracts are soon-to-expire. Thus, the name recognition process may begin near the expiry date of a seller's previous contract and may result in a higher conversion rate to agents using embodiments of the present invention.

Embodiments of the invention allow a similar prediction to be made to further refine the predictive client acquisition process. Because of the semi-automated nature of some embodiments of the present invention, more data may be exported and utilized than has previously been possible. Thus, embodiments of the present invention may scan active MLS listings 200a and track the expiry rate over time for particular real estate agents. This data can be used to predict a probability of a particular agent's listings expiring. When used in conjunction with predicting a time of expiry, this may be particularly useful in targeting another agent's listings and obtaining those clients efficiently upon expiry of their previous contracts. All this provides excellent opportunities to warm potential clients up before the initial solicitation phone call when the previous contract does expire. As the system further allows a real estate agent to easily track when a listing expires, ensures that the agent can make the initial call on the first available day, and ensures that the initial call on the first available day is not a cold call in that the agent's materials have recently been presented to the owner, the agent's success in capturing leads may be greatly enhanced.

Another feature embraced by some embodiments of the present invention takes advantage of the power of the computerized system to take advantage of the active MLS listings 200a in ways not previously available. For example, it has historically not been desirable for individual agents to search through and maintain information from active MLS listings 200a before expiry due to the large amounts of time involved and the high possibility of the time involved being wasted as a large number of active listings never expire as the property proceeds to sale. Instead, it has been more efficient to allow the listings to expire and the owner information to be stripped and to then proceed through the laborious process of locating the now-missing owner information.

Now, using the embodiments of the present invention, it is possible to take advantage of the computer's features to scan and database owner information from active MLS listings 200a before the active MLS listings 200a expire. This may he done even without using predictions as to expiry, as the large amounts of data may be stored at relatively little cost and discarded as properties are sold. In some embodiments, the data may be cross-checked with other active listings to eliminate and flag data that is obviously manipulated (such as repetitions of the agent's own contact information through multiple listings). Then, when some records do proceed to expiry, the owner information that was stripped away by the MLS system is already on record in the agent's database and may not need to be obtained from another source.

Some embodiments of the invention may also be used to allow others to help a real estate agent using the embodiments of the invention to improve his or her effectiveness. These others may include real estate agent coaches or coaching companies. These coaches or coaching companies need good data to understand what the real estate agent is doing that is working, and what is not working. Some embodiments of the invention may serve the real estate agent as an efficiency tracking tool or integrated accountability tracker, in conjunction with the other management features. For example, a management feature may provide the real estate agent with notifications as part of the drip campaign. One specific notification may be to place a personal phone call to a particular lead. The agent may click a button on the notification when the agent initiates the phone call, and another button when the call is complete. The program could then provide a prompt to the agent to enter the outcome of the telephone call.

The program could then keep track of the amount of time spent on the call and the entered outcome, and could correlate that data with similar data from other reminders and other actions. Over a period of time, the data would show how the agent has spent his/her time and what types of actions obtained the best results. Even if the agent is unable to best understand this data, the integrated accountability tracker may provide the data directly over a network link or Internet connection to the agent's coach or coaching company. There, skilled coaches could analyze the information and let the real estate agent know how he/she could improve his/her efficiency and effectiveness.

Another feature of some embodiments of the present invention provides an increased feeling of automaticity to the real estate agent using the present invention. As described above, some embodiments of the invention rely on the agent to log in to the agent's MLS system(s) and export data, in order to be compliant with the terms of use of the MLS systems. Unfortunately, this legitimate process is somewhat cumbersome even when it is greatly enhanced by the systems of the current invention. Therefore, other embodiments of the invention make use of a specific feature contained in many MLS agreements that recognizes that not all agents are able to spend the time necessary to export the desired data. This feature allows the agent to designate an assistant who is authorized to use the agent's login information to access the MLS database on behalf of the agent.

An assistant may, in some instances, be an actual employee of the agent physically located in an office with the agent. However, embodiments of the invention embrace the designation of an assistant of the real estate agent who is not an employee of the agent but is an employee of the service provider of the computer program embodying the invention. For example, a service provider may provide the initial client-based program (download), updates, and access to supplemental data services for a fixed monthly fee, and may further provide access to its employees as agent assistants. This could greatly enhance the agent's perception of the automatic nature of the embodiment of the invention.

For example, the remote assistant could have his/her own computer system linked to the agent's computer system through a dedicated connection within the client program. The remote assistant could then perform the data, exports/downloads and owner information searches during the night at a period during which the agent typically is not actively working. When the agent arrives at work in the morning, he/she would find his/her system ready with the updated work performed by the assistant during the night and transmitted directly to the agent without ever being available on a website or any other computer except the assistant's and the agent's. This system is advantageous in that it complies with the terms of use requirements of most MLS systems. Additionally, the agent does not have to do anything to receive the update: no e-mail attachment need be opened and read or entered, and the update occurs automatically overnight or as soon as the agent logs on in the morning. Additionally, where one agent might not be able to employ an assistant on his/her own, this type of arrangement allows one employee of the service provider to serve as an assistant for multiple agents and to divide his/her labor between several agents. This system does not use illicit automatic scrapers, but authorized physical manpower to export the data from the MLS systems and update it accordingly.

Some embodiments of the present invention rely on a novel software platform setup not previously available in the art. This software platform provides enhanced functionality and MLS compliance to service providers and real estate agents alike. The software platform relies on a “fat” client program rather than a web-based software program. That is, the software program is downloaded to and/or installed on the agent's computer (“client”) as a stand-alone program having local databases 120 where the information used by the program is stored. This allows the program to comply with MLS terms of use provisions requiring that the data obtained from the MLSs be used only on the agent's own computer system(s).

This system may also be advantageous to the service provider providing the program. While the service provider may also provide some services identified above, such as other database services and the provision of agent assistants performing the updating, certain features of the fat client allow the service provider unprecedented control over the fat client program. This functionality is provided by maintaining an active network connection/link between the fat client program and a managing program on the service provider server. This connection or link is beneficial for both the service provider and agent. The agent is benefited in that updates to the program may be readily provided as often as necessary: often multiple times per week. This may be useful as the interface with particular data sources changes or as additional data sources come on-line. The service provider benefits in that it is able to maintain increased control over its services and the use of its programs. Both parties may be benefited in that subscription payments may be facilitated by being made directly over the connection or link.

For example, the use of the fat client program may be provided as part of a subscription-based service. This has previously been unavailable in a client-based program, as once the program was activated, the service provider had no more control over how long the program was used. This is improved using the present invention, in that because of the active link between the program and the service provider, the service provider can activate or deactivate features of the program as the agent pays or fails to pay for those features. The updates and control signals may come through the same signals as that used for lead downloads, so the agent is unable to use the system to obtain leads without also providing the service provider with an opportunity to disable features not paid for. Thus, a server-side web application is able to maintain service provider control over a fat client subscription-based service in a way that has never previously been available.

Thus, although some embodiments of the present invention are particularly useful for the field of real estate brokerage, they may be used in other suitable fields as well.

It is evident from the description herein that the present invention offers several valuable advantages to the art of real estate brokerage. The present invention provides powerful automated searching features that search quickly and comprehensively, and that effectively provide near-instant real-time, up-to-date information on potential leads. In some embodiments of the present invention, management tools are available for the convenience of the user. The methods and systems of the present invention save time, money, and have the potential to significantly add to a real estate professional's bottom line.

The present invention may be embodied in other specific forms without departing from its spirit or essential characteristics. The described embodiments are to be considered in all respects only as illustrative and not restrictive. The scope of the invention is therefore indicated by the appended claims rather than by the foregoing description. All changes which come within the meaning and range of equivalency of the claims are to be embraced within their scope.

What is claimed is:

1. A computer-implemented method for providing potential real estate leads comprising:
retrieving expired listings from a MLS source, the expired listings each comprising a subset of data;
identifying data missing from the expired listings and searching for information to complete the missing data, the search comprising a computer-implemented automated search among a plurality of electronic sources; and
placing the expired listings and completed data into a database located on a computer-readable medium.

2. The method of claim 1 wherein the missing data comprises owner contact information.

3. The method of claim 1 wherein the expired listings are automatically updated.

4. The method of claim 1 further comprising flagging a phone number that is on a do-not-call list.

5. The method of claim 1 wherein the step of retrieving comprises utilizing a MLS export feature to export the expired listings.

6. The method of claim 1 wherein the step of retrieving comprises profiling the expired listings into a standardized format.

7. The method of claim 1 further comprising importing FSBO listings.

8. The method of claim 1 further comprising importing foreclosure listings.

9. The method of claim 1 further comprising searching additional sources and supplementing the database with data from the additional sources.

10. The method of claim 1 further comprising providing management tools.

11. The method of claim 1 further comprising providing a mail merge feature.

12. The method of claim 1 further comprising providing call scripting.

13. The method of claim 1 further comprising automatically standardizing any address information contained in any source into a standard address format.

14. A computer-readable medium comprising in instructions for:
importing real estate leads from at least one electronic source, the real estate leads each comprising a subset of data;
comparing the real estate leads with active listings on an MLS source to determine whether the real estate leads are valid leads, and updating the real estate leads accordingly; and
placing the updated real estate leads into a central database located on a computer device.

15. The medium of claim 14 wherein the instructions further comprise instructions for automatically notifying a user when a real estate lead comprising an expired listing has been re-listed.

16. The medium of claim 14 wherein the instructions further comprise instructions for automatically notifying a user when a real estate lead comprising a for-sale-by-owner listing has been listed on an MLS.

17. The medium of claim 14 wherein the instructions further comprise instructions for automatically notifying a user when a real estate lead comprising an expired listing has been sold.

18. The medium of claim 14 wherein the instructions further comprise instructions for automatically notifying a user when a real estate lead comprising a for-sale-by-owner listing has been sold.

19. The medium of claim 14 wherein the instructions further comprise instructions for identifying owner data missing from the real estate leads and searching for information to complete the missing owner data.

20. The medium of claim 14 wherein the instructions further comprise instructions for checking owner contact information for the real estate leads against a do-not-call list and for flagging a phone number that is on a do-not-call list.

21. A method for providing for the automated bulk import and standardization of large numbers of real estate leads in a system for managing real estate leads, the method comprising:
providing a real estate lead database in a system for managing real estate leads, the database having a plurality of lead data fields, each lead data field corresponding to a useful piece of information for a real estate lead;
providing a source of information containing data about real estate leads, the source of information comprising a source database having a plurality of source data fields corresponding to useful information for the real estate leads;
mapping the source data fields on the source database to their corresponding lead data fields on the real estate lead database;
connecting the system for managing real estate leads to the source of information;
importing in bulk a plurality of information from the source database into the system for managing real estate leads; and
profiling automatically and in bulk the imported information contained in the imported source data fields into the lead data fields in the real estate lead database.

22. The method of claim 21 wherein the mapping the source data fields on the source database to their corresponding lead data fields on the real estate lead database occurs during an initial retrieval of information from the source of information.

23. The method of claim 21 wherein the mapping is done manually by a user of the system for managing real estate leads.

24. The method of claim 21 wherein the mapping is done automatically and intelligently by the system for managing real estate leads by a method selected from the group of:
utilizing source data field descriptors contained on the source database and comparing the source data field descriptors with lead data field descriptors contained on the real estate lead database; and
searching through information contained on the source database for meaningful identifiable source information identifying the source data fields.

25. A computer data signal embodied in a transmission medium such as a carrier wave comprising instructions for:
importing in bulk real estate leads from a first plurality of electronic sources;
identifying data missing from the leads and searching for information to complete the missing data, the search comprising a computer-implemented automated search among a second plurality of electronic sources;
profiling the leads and data received from the first and second pluralities of electronic sources into a standard format;
periodically automatically updating the leads by periodically comparing them with a third plurality of electronic sources; and
making the profiled updated leads available for display on an output interface of a computer device.

26. The data signal of claim 25 wherein the instructions further comprise instructions for automatic notification to a user when a lead has been sold, and automatic notification to a user when a lead has been listed with a real estate agent.

27. The data signal of claim 25 wherein the instructions further comprise instructions for automated searching for and supplementing of the leads with additional information retrieved from a fourth plurality of electronic sources.

28. The data signal of claim 25 wherein the bulk importing comprises importing leads from at least one of:
an expired MLS listing source;
an active MLS listing source;
a FSBO listing source;
a foreclosure listing source;
a pre-foreclosure/notice of default listing source; and
an other lead source related to buyer/seller leads.

29. A computer-implemented method for utilizing just listed and just sold databases as sources for real estate leads, the method comprising:
providing a real estate lead managing computer system;
providing the real estate lead managing computer system with access to a database containing at least one of:
just sold listings; and
just listed listings;
identifying a property contained on the database;
performing a radius identifying other properties located within a certain distance of the property contained on the database; and
sending a solicitation to the owners of the other properties.

30. The computer-implemented method of claim 29 wherein the solicitation includes an automatically-generated comprehensive report and market analysis analyzing relevant real estate sales data from local properties near the other properties, the report and market analysis being generated by the real estate lead management computer system.

31. The computer-implemented method of claim 29 wherein the sending a solicitation to the owners of the other properties comprises:
providing a link to a fulfillment software module;
providing a report and fulfill function on the real estate lead managing computer system; and
generating automatically a solicitation when the report and fulfill function is selected.

32. The computer-implemented method of claim 29 wherein the sending a solicitation to the owners of the other properties comprises sending a request for solicitation fulfillment to an external fulfillment center.

33. A computer-implemented method for predicting when an active MLS listing will expire to allow a real estate agent to use the active MLS listing as a real estate lead, the method comprising:
providing a computer communicatively coupled to an electronic MLS source;
retrieving expired listings from the electronic MLS source using the computer, the expired listings each comprising a subset of data including agent information, a listing date, and an expiry date;
scanning the retrieved expired listings using the computer to identify a plurality of expired listings by a particular real estate agent or broker;
identifying the listing date and the expiry date for each of the plurality of expired listings by the particular real estate agent or broker using the computer;
calculating a typical listing contract term used by the particular real estate agent or broker using the listing dates and the expiry dates for the plurality of expired listings by the particular real estate agent or broker using the computer;
retrieving an active listing from the electronic MLS source using the computer, the active listing comprising a listing by the particular real estate agent or broker and include a listing date; and
predicting the expiry of the active listing by applying the typical listing contract term to the listing date of the active listing.

34. The computer-implemented method of claim 33, further comprising:
determining correct owner contact information for the active listing; and
beginning solicitation of the owner of the active listing as the active listing nears expiry.

35. The computer-implemented method of claim 33, further comprising predicting a probability that the active listing will expire, the predicting the probability that the active listing will expire comprising:
importing a plurality of additional active listings from the electronic MLS source, the plurality of additional active listings comprising listings by the particular real estate agent;
determining the listing date for any of the plurality of additional active listings comprising listings by the particular real estate agent;
ascertaining whether any of the plurality of additional active listings comprising listings by the particular real estate agent have been sold;
discovering whether any listings by the particular real estate agent have recently expired;
repeating the steps of importing, determining, ascertaining, and discovering over a period of time; and
calculating a percentage of active listings by the particular real estate agent that proceed to expiry.

36. A computer-implemented method for automatically providing a drip campaign to solicit an owner of real estate comprising a real estate lead to list with a real estate agent, the method comprising:
providing a computer accessible by a first real estate agent having a real estate lead management software system;
receiving a real estate lead on the software system;
obtaining owner information for the real estate lead, the owner information comprising owner contact information;
verifying that the owner does not have an exclusive listing agreement with a second real estate agent and that the owner has not sold the real estate; and
establishing a drip campaign to solicit the owner to list with the first real estate agent,
wherein:
the drip campaign is managed by the real estate lead management software;
the drip campaign includes a list of actions to be taken at certain times calculated to best obtain a listing from the owner with the first real estate agent; and
the real estate lead management software provides automated reminders to the first real estate agent to perform the actions at the certain times.

37. The computer-implemented method of claim 36, wherein the receiving a real estate lead on the software system comprises receiving a sphere of influence real estate lead from a manual or automatic electronic entry by the first real estate agent.

38. The computer-implemented method of claim 36, wherein the receiving a real estate lead on the software system comprises importing the real estate lead from an electronic source communicatively coupled to the computer.

39. The computer-implemented method of claim 38, wherein the electronic source of the real estate lead is selected from the group of:
an expired MLS listing source;
an active MLS listing source;
a FSBO listing source;
a foreclosure listing source;
a fire-foreclosure/notice of default listing source; and
an other lead source related to buyer/seller leads.

40. The computer-implemented method of claim 36 wherein the list of actions to be taken at certain times calculated to best obtain the listing from the owner comprises at least one of:
a predetermined set of actions provided with the real estate lead management software system;
a predetermined set of actions provided with the real estate lead management software system and modified by the first real estate agent;
a predetermined set of actions provided with the real estate lead management software system and customized for use with a certain type of real estate lead; and
a custom set of actions selected by the real estate agent and saved in the real estate lead management software.

41. A computer-implemented method for providing real estate agent efficiency tracking to a real estate agent using a computer software product for managing real estate leads, the method comprising:
providing a computer accessible by a first real estate agent and having a real estate lead management computer software product;
receiving a plurality of real estate leads on the computer;
confirming that each of the plurality of real estate leads is a valid real estate lead that has not been sold and is not actively listed with a second real estate agent using the computer software product;
establishing a set of actions to be taken at certain times for each valid real estate lead using the computer software product, the set of actions calculated to best obtain a listing with the first real estate agent from the real estate lead;
providing a notification reminder to the first real estate agent for each action to be taken using the computer software product;
providing an outcome entry for each action to be taken wherein the first real estate agent can record an action taken by the real estate agent and an outcome resulting from the action taken using the computer software product;
compiling the outcome entry for each action taken into an efficiency report showing the first real estate agent which actions were efficient in obtaining listings using the computer software product; and
providing the efficiency report to the first real estate agent using the computer software product.

42. The method of claim 41, further comprising:
tracking the amount of time the first real estate agent spends on each action taken; and
including the time spent as part of the efficiency report.

43. The method of claim 41, further comprising:
providing a communicative connection between the computer accessible by the first real estate agent and a computer accessible by a real estate coach or real estate coaching company;
providing the efficiency report to the real estate coach or real estate coaching company through the communicative connection; and
providing an evaluation of the efficiency report by the real estate coach or real estate coaching company to the first real estate agent through the communicative connection.

44. A computer-implemented method for providing real estate leads in a system that appears to a real estate agent accessing the system to receive and update the real estate leads in an automatic fashion while simultaneously complying with terms of access rules governing MLS systems, the method comprising:
providing a fat client computer program on a computer controlled by a real estate agent subscribing to a MLS database, the fat client computer program being provided by a service provider;
providing an exclusive communicative connection between the fat client computer program on the real estate agent computer and a service provider program located on a service provider computer;
designating an employee of the service provider as an assistant of the real estate agent, and the service provider computer as the assistant's computer;
having the assistant perform real estate lead management actions on the service provider computer, the real estate lead management actions comprising:
importing real estate leads from at least one electronic source, the real estate leads each comprising a subset of data;
comparing the real estate leads with active listings on an MLS source using a subscription of the real estate agent to determine whether the real estate leads are valid leads, and updating the real estate leads accordingly;
placing the updated real estate leads into a database located on the service provider computer;
sending the updated real estate leads over the exclusive communicative connection to the fat client computer program as an update to the fat client computer program; and
deleting the updated real estate leads from the service provider computer designated as the assistant's computer;
receiving the updated real estate leads at the real estate agent computer over the exclusive communicative connection;
updating a real estate lead database on the real estate agent computer with the received updated real estate leads; and
making the updated real estate leads available for display on an output interface of the real estate agent computer.

45. The method of claim 44 wherein the real estate lead management actions performed by the assistant occur during a time when the real estate agent is not actively utilizing the real estate agent computer, and wherein the receiving the updated real estate leads and the updating a real estate lead database on the real estate agent computer occur automatically without the real estate agent performing any affirmative action.

46. A method for providing a subscription-based fat client software program wherein the service provider of the software program is able to maintain control over the use of the program based on the timely payment of necessary subscription fees and is further able to control the activation and deactivation of software features, the method comprising:
providing a client computer controlled by a client;
providing a service provider computer having a subscription control program;
providing a communicative connection between the client computer and the service provider computer;
providing a fat client software program on the client computer, wherein:
the fat client software program comprises all the software modules and instructions necessary to perform a set of functions required of the fat client software program;
the fat client software program is in communication with the subscription control program on the service provider computer via the communicative connection;
the fat client software program responds to communications from the subscription control program via the communicative connection to activate or deactivate modules of the fat client software program; and
in the absence of a communicative connection for a predetermined amount of time, the fat client software program disables one or more modules of the fat client software program;
monitoring the status of subscription payments due/received from the client; and
sending an activation/deactivation signal from the service provider computer over the communicative connection to the client computer that activates/deactivates at least one module of the fat client software program based on the status of the subscription payments due/received from the client.

47. The method of claim 46, wherein the fat client software program is a real estate lead management software program.

48. The method of claim 46, further comprising receiving an update to the fat client software program from the service provider over the communicative connection.

49. The method of claim 46, wherein the fat client software program is downloaded to the client computer from the service provider computer over the communicative connection.
